(19) United States
(12) Patent Application Publication
(10) Pub. No.: US 2022/0390042 A1
(43) Pub. Date: Dec. 8, 2022

(54) CONDUIT MANAGEMENT DEVICE

(71) Applicant: R.A. PHILLIPS INDUSTRIES, INC., Santa Fe Springs, CA (US)

(72) Inventors: Thomas Dale Peterson, Wilsonville, OR (US); Jonathon Michael Boyd, Fullerton, CA (US)

(21) Appl. No.: 17/832,311

(22) Filed: Jun. 3, 2022

Related U.S. Application Data
(60) Provisional application No. 63/196,611, filed on Jun. 3, 2021.

(51) Int. Cl. F16L 3/137; F16L 3/10; F16L 3/223

(52) U.S. Cl. CPC F16L 3/137; F16L 3/105; F16L 3/1058; F16L 3/2235

(57) ABSTRACT

A cable management device includes a central portion, and a plurality of dividers extending away from a central axis of the central portion, the plurality of dividers defining a plurality of receptacles therebetween, the plurality of receptacles being configured to receive a plurality of conduits, the plurality of dividers defining a recessed channel extending along an outer circumference of the dividers and configured to accommodate a securing mechanism for securing the plurality of conduits to the cable management device.

### CROSS-REFERENCE TO RELATED APPLICATION(S)

This application claims priority to, and the benefit of, U.S. Provisional Application No. 63/196,611 (“CONDUIT MANAGEMENT DEVICE”), filed on Jun. 3, 2021, the entire content of which is incorporated herein by reference.

### FIELD

Embodiments of the present invention relate to the field of conduit management in tractor-trailer vehicles.

### BACKGROUND

A tractor-trailer vehicle, which includes a tractor and a trailer pulled by the tractor, often has a number of electrical cables and air hoses extended between the tractor and trailer. These electrical cables and air hoses, which are henceforth generally referred to as conduits, are secured at each end to moving anchor points at the tractor and trailer. In the related art, the air and electrical conduits are wrapped with a helical wrap that protects the conduits from damage, particularly when the vehicle is moving. The protective wrap makes repair of damaged hoses difficult because the entire wrap must be removed to replace the hose. Therefore, some users opt to bundle the air/electrical assembly using cable ties; however, this is not a desirable solution as the cable ties can bite into and damage the hoses and/or cables.

What is desired is an effective conduit management device that can be easily installed and removed and that can safely secure flexible conduits between the tractor and trailer.

The above information disclosed in this Background section is only for enhancement of understanding of the invention, and therefore it may contain information that does not form the prior art that is already known to a person of ordinary skill in the art.

### SUMMARY

Aspects of some embodiments of the invention are directed toward a durable and easy-to-install-and-remove cable management device for supporting and guiding conduits extending between interconnected vehicle components. In some embodiments, the cable management device has clover shape with a plurality of cavities capable of securely engaging and holding air and electrical lines that run between a tractor and trailer.

According to some embodiments of the present disclosure, there is provided a cable management device including: a central portion; and a plurality of dividers extending away from a central axis of the central portion, the plurality of dividers defining a plurality of receptacles therebetween, the plurality of receptacles being configured to receive a plurality of conduits, the plurality of dividers defining a recessed channel extending along an outer circumference of the dividers.

In some embodiments, the plurality of dividers include radial dividers extending radially away from the central axis of the central portion.

In some embodiments, each divider of the plurality of dividers has a wide outer end and a tapered stem between the wide outer end and the central portion.

In some embodiments, each one of the plurality of receptacles has a concave portion corresponding in shape and size to an outer circumference of a corresponding one of the plurality of conduits.

In some embodiments, the concave portion of each one of the plurality of receptacles is circularly arced.

In some embodiments, the plurality of dividers includes three radial dividers separated at 120° angles and defining three circularly-arced receptacles.

In some embodiments, at least one of the plurality of receptacles has a size different from an other one of the plurality of receptacles.

In some embodiments, top surfaces of the wide outer ends form circular arcs having a same radius.

In some embodiments, an opening of a receptacle of the plurality of receptacles that is defined by neighboring ends of wide outer ends of adjacent dividers of the plurality of dividers is smaller than a maximum inner diameter of the receptacle.

In some embodiments, a receptacle of the plurality of receptacles is configured to wrap around about 300 degrees of a circumference of a corresponding conduit of the plurality of conduits.

In some embodiments, the recessed channel forms a partial annular groove.

In some embodiments, the recessed channel has a substantially rectangular cross-sectional profile.

In some embodiments, the cable management device further includes: a securing mechanism configured to wrap around the cable management device, wherein the recessed channel is configured to accommodate the securing mechanism for securing the plurality of conduits to the cable management device.

In some embodiments, when a conduit is secured within a receptacle of the plurality of receptacles, a radius of an inner surface of the recessed channel is greater than a maximum distance between an outer surface of the conduits and a center of the central portion.

In some embodiments, the recessed channel has a width of about 3 mm to about 7 mm, and a depth of about 2 mm to about 4 mm.

In some embodiments, a radius of a top surface of a wide outer end of a divider of the plurality of dividers is about 2 inches to about 3 inches, and

wherein a thickness of the wide outer end along the central axis is about 15 mm to about 25 mm.

In some embodiments, the plurality of dividers include flexible material.

In some embodiments, the central portion and the plurality of dividers include a thermoset elastomer material with a hardness of about 60 A to about 70 A durometer.

In some embodiments, one or more of the plurality of receptacles do not extend radially from the central axis of the central portion.

### BRIEF DESCRIPTION OF THE DRAWINGS

The accompanying drawings, together with the specification, illustrate exemplary embodiments of the invention, and, together with the description, serve to explain aspects of embodiments of the invention. In the drawings, like reference numerals are used throughout the figures to reference like features and components. The figures are not necessarily drawn to scale. The above and other features and aspects of the invention will become more apparent from the following detailed description of illustrative embodiments thereof with reference to the attached drawings, in which:

FIGS. 1A, 1B, and 1C illustrate front, side, and perspective views of the cable management device, according to some example embodiments of the present disclosure.

FIGS. 2A and 2B illustrate different perspective views of the cable management device while securely bundling together a plurality of conduits, according to some example embodiments of the present disclosure.

FIG. 2C illustrates the use of the cable management device for supporting and guiding conduits that are extended between interconnected vehicle components, according to some example embodiments of the present disclosure.

FIGS. 3A, 3B, and 3C illustrate cross-sections of different configurations of the cable management device, according to some example embodiments of the present disclosure.

### DETAILED DESCRIPTION

The detailed description set forth below is intended as a description of example embodiments of the invention, and is not intended to represent the only forms in which the invention may be constructed or utilized. The description sets forth the features of the invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

Aspects of some embodiments of the invention are directed to a cable management device having a plurality of cavities at its perimeter that are configured to secure air and electric lines. In some examples, these lines/conduits are coupled between the back of a tractor and the front a trailer. In some embodiments, the cable management device may be generally cylindrical in shape and have concave receptacles that are configured to securely grasp the conduits with about 300 degrees of conduit support. In some embodiments, the cable management device has a recessed channel along the perimeter of the device which is configured to accept and accommodate a securing mechanism (e.g., a cable tie) for securing the conduits to the cable management device. The device may have a larger diameter than the air/electrical bundle so that the securing mechanism does not come in contact with the conduits, thus eliminating any potential for damage from the securing mechanism. The cable management device may be sufficiently flexible to allow for easy attachment to, and detachment from, the conduits. In some examples, the device may be made of an elastic material, such as a thermoset elastomer with a hardness of about 60 A to about 70 A durometer (e.g., about 65 A durometer).

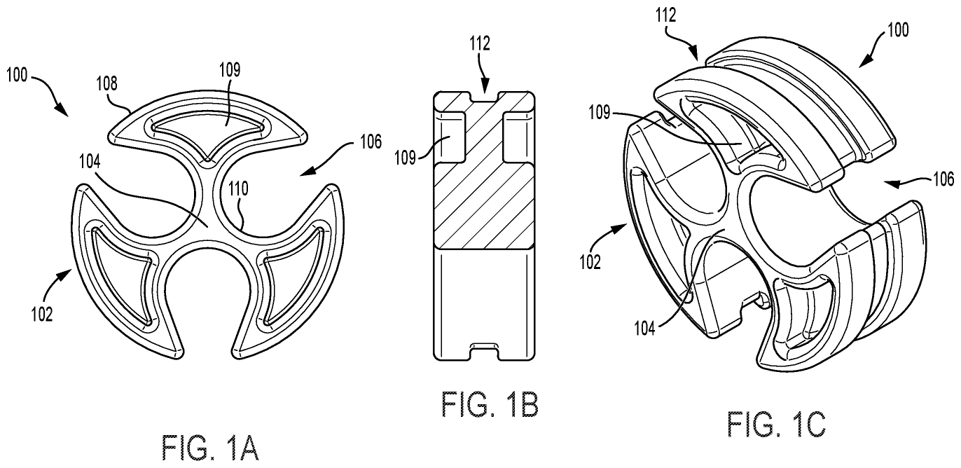

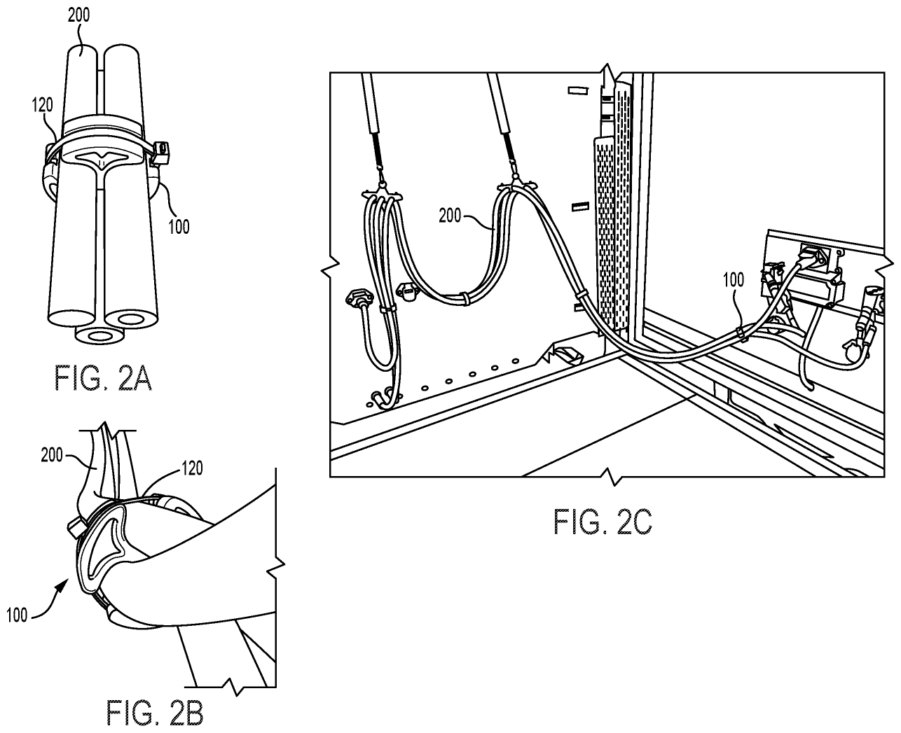

FIGS. 1A-1C illustrate front, side, and perspective views of the cable management device, according to some embodiments of the present disclosure. FIGS. 2A-2C illustrate perspective views of the cable management device while securely bundling together a plurality of conduits, according to some embodiments of the present disclosure.

The cable management device 100 has a generally cylindrical profile that extends axially along a central axis. In some embodiments, the cable management device 100 includes a plurality of dividers (e.g., radial dividers) 102 extending away (e.g., extending radially away) from a central portion 104 of the cable management device 100 and defining a plurality of receptacles 106 therebetween. Each one of the plurality of dividers 102 has a wide outer end 108 and a tapered stem 110 between the wide outer end 108 and the central portion 104 of the cable management device 100. In some embodiments, the tapered stems 110 have a funnel-shaped profile and define concave (e.g., circularly arced) receptacles 106 therebetween, which are configured to receive a plurality of conduits 200 (e.g., air and/or electric lines). The concave portion of each of the receptacles 106 may correspond in shape and size to an outer circumference of a corresponding one of the plurality of conduits 200.

The cable management device 100 may be made of one or more flexible materials to allow a user (e.g., the vehicle driver or maintenance person) to easily attach the conduits 200 to, and detach them from, the cable management device 100. In some examples, the flexible material may be a thermoset elastomer with an approximate hardness of about 65 A durometer. However, embodiments of the present disclosure are not limited thereto, and any suitable flexible material of any suitable hardness may be used.

The outer surfaces of the wide outer ends 108 may be arced, and, in some examples, may form circular arcs. For example, the radius of the top surfaces of the wide outer ends 108 may be about 2 inches to about 3 inches. The wide outer ends 108 may be about 15 mm to about 25 mm (e.g., about 20 mm) thick along the direction of the central axis. Adjacent wide outer ends 108 may be sufficiently distanced from one another to allow a conduit 200 to be inserted in the corresponding receptacle 106. The receptacle opening defined by neighboring ends of adjacent wide outer ends 108 may be smaller than the maximum inner diameter of the receptacle 106 (e.g., smaller than the diameter of the conduit 200 that is intended to be accommodated by the receptacle 106). This may allow the dividers 102 to grip the conduits 200 and to restrict outward movement of the conduits 200 from the corresponding receptacles 106. The receptacle opening is also sized to allow for easy attachment of the corresponding conduit 200. In some examples, each receptacle 106 may wrap around (and, e.g., contact) about 290 degrees to about 310 degrees (e.g., about 300 degrees) of the circumference of the supported conduit 200.

According to some embodiments, the cable management device 100 has a recessed channel (e.g., groove) 112 extending along an outer circumference thereof. As shown in FIGS. 1B-1C, the recessed channel 112 may form a partial annular groove, which may have a substantially rectangular cross-sectional profile. The recessed channel 112 may be configured to accommodate a securing mechanism (e.g., a cable tie or fastener) 120 for tightly securing (e.g., tightly fastening) the conduits 200 to the cable management device 100. The depth of the recessed channel 112 may be more than the thickness of the securing mechanism (e.g., the cable tie) 120 to ensure that the securing mechanism 120, once fastened around the outer periphery of the dividers 102, stays within and does not slip out of the recessed channel 112 when the cable bundle is subject to swings and shakes during normal use. In some examples, the recessed channel 112 may be about 3 mm to about 7 mm (e.g., about 5.6 mm) wide (e.g., along the direction of the central axis) and about 2 mm to about 4 mm deep (e.g., along a radial direction).

While FIGS. 1B-1C illustrate the recessed channel 112 having a substantially rectangular cross-sectional profile to match a rectangular profile of a cable tie, embodiments of the present disclosures are not limited thereto. For example, the recessed channel 112 may have a cross-sectional profile that substantially matches that of the securing mechanism 120, and may be substantially semi-circular, trapezoidal, or any other suitable shape.

In some embodiments, the diameter of inner surface of the recessed channel 112 is greater than the diameter of the conduit bundle, such that there is a gap between the securing mechanism 120 and the outer surface of the conduits 200. This ensures that the securing mechanism 120 does not come in contact with conduits 200, therefore eliminating any risk of conduit damage from the securing mechanism 120. In some examples, the gap may be about 2 mm to about 4 mm.

As shown in the examples of FIGS. 1A-2C, the cable management device 100 may include three identical radial dividers 102 separated at about 120° angles, which define three identical circularly-arced receptacles. However, embodiments of the invention are not limited thereto. For example, the cable management device 100 may include any suitable number of dividers 102 and corresponding receptacles 106 to receive any desirable number of conduits 200. Further, at least one of the receptacles 106 may be different in size from the other receptacles 106. Furthermore, the receptacles 106 may have any suitable cross-sectional shape to accommodate any suitable conduit 200.

In some embodiments, opposing sides of each wide outer end 108 along the central axis have hollow regions (e.g., depressed regions) 109, which improve the flexibility of the cable management device 100 thus easing attachment/detachment of the conduits 200. The hollow regions 109 also help to reduce the weight of the cable management device 100, which lessens the pull on the conduits 200 and any harnesses they are attached to. As shown in FIG. 1B, opposing hollow regions 109 may be depressions in the wide outer end 108 that are separated by a solid portion of the wide outer end 108; however, embodiments of the present disclosure are not limited thereto, and the opposing hollow regions 109 may join to form a single through hole passing through the wide outer end 108.

In some embodiments, the cable management device 100 may be a disk with openings formed therein to receive one or more conduits 200.

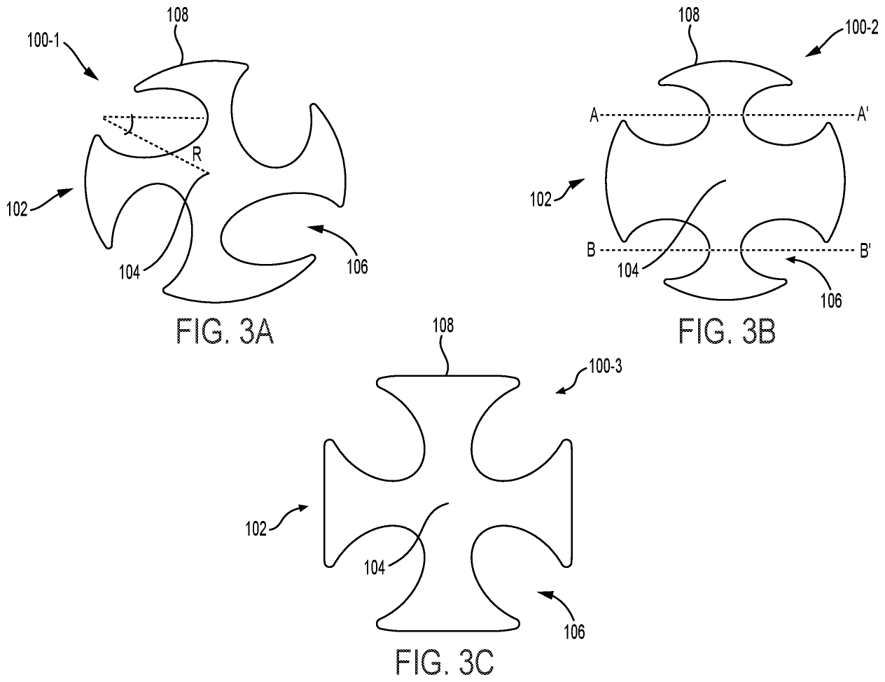

While FIGS. 1A-1C illustrate embodiments in which the cable management device 100 has radial symmetry, embodiments of the present disclosure are not limited thereto. That is, one or more of the plurality of receptacles 106 may not extend radially from the central axis of the central portion 104. For example, as shown in FIG. 3A, the receptacles 106 may extend at an angle relative to a corresponding radial direction R. In some examples, the receptacles 106 may be arranged along one or more straight lines (e.g., lines AA′ and BB′, as shown in FIG. 3B). Further, embodiments of the present disclosure are not limited to the cable management device having a substantially circular cross-section, and the device may have any suitable cross-sectional shape. For example, as shown in FIG. 3C, the cable managements device 100-3 may have a substantially rectangular (e.g., square) cross-sectional shape. In FIGS. 3A-3C, the hollow regions 109 and the recessed channel 112 are not shown for ease of illustration.

Accordingly, as described above, embodiments of the present disclosure provide a durable and easy to use cable management device for supporting and guiding conduits that are extended between interconnected vehicle components.

While this invention has been described in detail with particular references to exemplary embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

The terminology used herein is for the purpose of describing particular embodiments and is not intended to be limiting of the inventive concept. As used herein, the singular forms “a” and “an” are intended to include the plural forms as well, unless the context clearly indicates otherwise. Further, the use of “may” when describing embodiments of the inventive concept refers to “one or more embodiments of the inventive concept”. Also, the term “exemplary” is intended to refer to an example or illustration.

It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. When an element or layer is referred to as being “directly on”, “directly connected to”, “directly coupled to”, or “immediately adjacent to” another element or layer, there are no intervening elements or layers present.

As used herein, the terms “use”, “using”, and “used” may be considered synonymous with the terms “utilize”, “utilizing”, and “utilized”, respectively.

What is claimed is:

1. A cable management device comprising:
a central portion; and
a plurality of dividers extending away from a central axis of the central portion, the plurality of dividers defining a plurality of receptacles therebetween, the plurality of receptacles being configured to receive a plurality of conduits, the plurality of dividers defining a recessed channel extending along an outer circumference of the dividers and configured to accommodate a securing mechanism for securing the plurality of conduits to the cable management device.

2. The cable management device of claim 1, wherein the plurality of dividers comprise radial dividers extending radially away from the central axis of the central portion.

3. The cable management device of claim 1, wherein each divider of the plurality of dividers has a wide outer end and a tapered stem between the wide outer end and the central portion.

4. The cable management device of claim 1, wherein each one of the plurality of receptacles has a concave portion corresponding in shape and size to an outer circumference of a corresponding one of the plurality of conduits.

5. The cable management device of claim 4, wherein the concave portion of each one of the plurality of receptacles is circularly arced.

6. The cable management device of claim 1, wherein the plurality of dividers comprises three radial dividers separated at 120° angles and defining three circularly-arced receptacles.

7. The cable management device of claim 1, wherein at least one of the plurality of receptacles has a size different from an other one of the plurality of receptacles.

8. The cable management device of claim 1, wherein top surfaces of the wide outer ends form circular arcs having a same radius.

9. The cable management device of claim 1, wherein an opening of a receptacle of the plurality of receptacles that is defined by neighboring ends of wide outer ends of adjacent dividers of the plurality of dividers is smaller than a maximum inner diameter of the receptacle.

10. The cable management device of claim 1, wherein a receptacle of the plurality of receptacles is configured to wrap around about 290 degrees to about 310 degrees of a circumference of a corresponding conduit of the plurality of conduits.

11. The cable management device of claim 1, wherein the recessed channel forms a partial annular groove.

12. The cable management device of claim 1, wherein the recessed channel has a substantially rectangular cross-sectional profile.

13. The cable management device of claim 1, further comprising:
the securing mechanism that is configured to wrap around the cable management device.

14. The cable management device of claim 1, wherein when a conduit is secured within a receptacle of the plurality of receptacles, a radius of an inner surface of the recessed channel is greater than a maximum distance between an outer surface of the conduits and a center of the central portion.

15. The cable management device of claim 1, wherein the recessed channel has a width of about 3 mm to about 7 mm, and a depth of about 2 mm to about 4 mm.

16. The cable management device of claim 1, wherein a radius of a top surface of a wide outer end of a divider of the plurality of dividers is about 2 inches to about 3 inches, and
wherein a thickness of the wide outer end along the central axis is about 15 mm to about 25 mm.

17. The cable management device of claim 1, wherein the plurality of dividers comprise flexible material.

18. The cable management device of claim 1, wherein the central portion and the plurality of dividers comprise a thermoset elastomer material with a hardness of about 60 A to about 70 A durometer.

19. The cable management device of claim 1, wherein one or more of the plurality of receptacles do not extend radially from the central axis of the central portion.
